(19) United States
(12) Patent Application Publication
(10) Pub. No.: US 2025/0189872 A1
(43) Pub. Date: Jun. 12, 2025

(54) REFLECTIVE MODULE AND CAMERA MODULE COMPRISING SAME

(71) Applicant: SAMSUNG ELECTRO-MECHANICS CO., LTD., Suwon-si (KR)

(72) Inventors: Hong Joo LEE, Suwon-si (KR); Jung Woo KIM, Suwon-si (KR)

(73) Assignee: SAMSUNG ELECTRO-MECHANICS CO., LTD., Suwon-si (KR)

(21) Appl. No.: 18/928,967

(22) Filed: Oct. 28, 2024

(30) Foreign Application Priority Data
Dec. 7, 2023 (KR) 10-2023-0176767

(51) Int. Cl. G03B 17/17; G03B 5/06

(52) U.S. Cl. CPC G03B 17/17; G03B 5/06; G03B 2205/0023; G03B 2205/0046; G03B 2205/0069

(57) ABSTRACT

A camera module is provided. The camera module includes: a housing; a reflection module disposed in the housing, and configured to receive light in a first direction; and a yoke disposed in the housing, wherein the reflection module includes a magnet disposed on a lower portion of the reflection module, and a ball member disposed between the reflection module and the housing and configured to support a rotation of the reflection module. Magnetic force acting between the magnet and the yoke may be changed when the reflection module is rotated from the neutral position.

### CROSS-REFERENCE TO RELATED APPLICATIONS

This application claims the benefit under 35 USC § 119(a) of Korean Patent Application No. 10-2023-0176767 filed on Dec. 7, 2023, in the Korean Intellectual Property Office, the entire disclosure of which is incorporated herein by reference for all purposes.

### BACKGROUND

### 1. Field

The following description relates to a reflection module and a camera module comprising the same.

### 2. Description of Related Art

Camera modules that are disposed in mobile devices may be manufactured to have a performance that is comparable to that of typical cameras. In particular, there is an increased demand for camera modules that may provide a high zoom ratio due to an increased frequency of capturing images by using the mobile device.

The camera module may adjust the zoom ratio by moving a lens module. In order to configure the high zoom ratio, it is necessary to secure a sufficient distance for light incident on the camera module to travel to an image sensor, that is, a total length or total track length (TTL). In order to implement a long total track length, the camera module may have an increased overall length. However, since the form factor of mobile devices is increasingly smaller, there may be a space limitation in sufficiently extending the length of the camera module.

Therefore, there is a need for a structure that may form an optical path as long as possible without increasing the overall length of the camera module or while reducing the overall length of the camera module.

Additionally, recent camera modules may include a movable or rotatable reflector that refracts or reflects light to thus form a longer optical path while performing an optical image stabilization (OIS) operation.

The reflector may be disposed in the reflection module. The reflector may be rotated by the reflection module, and the reflection module may be disposed while being rotated when a current applied to an actuator is recovered after the reflection module is driven and rotated by the actuator.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, a camera module includes a housing; a reflection module disposed in the housing, and configured to receive light in a first direction; and a yoke disposed in the housing, wherein the reflection module includes: a magnet disposed on a lower portion of the reflection module, and a ball member disposed between the reflection module and the housing, and configured to support a rotation of the reflection module, wherein when the reflection module is in a neutral position, a portion of the magnet is disposed in a non-overlapping manner with the yoke in the first direction.

The magnet may include a first driving magnet and a second driving magnet spaced apart from each other while having the ball member interposed therebetween.

When the reflection module is rotated from the neutral position, a magnetic force acting between the first driving magnet and the yoke in a direction perpendicular to the first direction may be inversely proportional to a magnetic force acting between the second driving magnet and the yoke in the direction perpendicular to the first direction.

A magnetic force acting between the magnet and the yoke may be changed when the reflection module is rotated from the neutral position.

When the reflection module is in the neutral position, a first portion of the first driving magnet may overlap a first portion of the yoke in the first direction, and a first portion of the second driving magnet may overlap a second portion of the yoke in the first direction.

The yoke may include a main body, a first extension portion and a second extension portion respectively protruding from the main body, and the ball member may be disposed between the first extension portion and the second extension portion.

The magnet may include a first driving magnet and a second driving magnet that are spaced apart from each other while having the ball member interposed therebetween, a first portion of the first driving magnet may overlap the first extension portion in the first direction, and a first portion of the second driving magnet may overlap the second extension portion in the first direction.

The magnet may include a first driving magnet and a second driving magnet that are spaced apart from each other while having the ball member interposed therebetween, and when the reflection module is in the neutral position, an end portion of the first driving magnet may be spaced apart from an end portion of the first extension portion in a direction perpendicular to the first direction, and an end portion of the second driving magnet may be spaced apart from an end portion of the second extension portion in the direction perpendicular to the first direction.

An area where the second extension portion and the second driving magnet overlap each other may be increased when an area where the first extension portion and the first driving magnet overlap each other is reduced when the reflection module is rotated.

The yoke may have a “U” shape.

In a general aspect, a camera module includes a housing; a reflection module disposed in the housing, and configured to receive light in a first direction; a yoke disposed in the housing; a magnet disposed on a lower portion of the reflection module; and a ball member disposed between the reflection module and the housing, to configured to support a rotation of the reflection module, wherein when the reflection module is in a neutral position, an entirety of the magnet overlaps the yoke in the first direction, and one end of the magnet partially overlaps an edge of the yoke in the first direction.

The magnet may include a first driving magnet and a second driving magnet spaced apart from each other while having the ball member interposed therebetween.

When the reflection module is rotated from the neutral position, a magnetic force acting between the first driving magnet and the yoke in a direction perpendicular to the first direction may be inversely proportional to a magnetic force acting between the second driving magnet and the yoke in the direction perpendicular to the first direction.

The yoke may include a main body, a first extension portion and a second extension portion respectively protruding from the main body, and the ball member may be disposed between the first extension portion and the second extension portion.

An area where the second extension portion and the second driving magnet overlap each other may be increased when an area where the first extension portion and the first driving magnet overlap each other is reduced when the reflection module is rotated.

When the reflection module is rotated clockwise, an end of the first driving magnet may be closer to the main body in a clockwise direction, and an end of the second driving magnet may be further away from the main body in a clockwise direction.

In a general aspect, a camera module includes a housing; a reflection module disposed in the housing; a first driving magnet and a second driving magnet respectively disposed on a lower portion of the reflection module; and a yoke disposed in the housing to face the first driving magnet and the second driving magnet in a first axis direction; wherein when the reflection module is disposed in a first position, a first end of the first driving magnet is substantially equal to a first end of the yoke, and a first end of the second driving magnet is substantially equal to a second end of the yoke, wherein when the reflection module is rotated in a first rotation direction, an overlapping area of the yoke and the first driving magnet is reduced, and an overlapping area of the yoke and the second driving magnet is increased, and wherein when the reflection module is rotated in a second rotation direction, an overlapping area of the yoke and the first driving magnet is increased, and an overlapping area of the yoke and the second driving magnet is reduced.

The first direction may be a clockwise direction, and the second direction may be a counterclockwise direction.

The reflection module may be disposed in the first position a magnetic force between the yoke and the first driving magnet is substantially equal to a magnetic force between the yoke and the second driving magnet.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of some of the components in the example camera module, in accordance with one or more embodiments.

FIG. 3 illustrates a cross-sectional view of the example camera module, in accordance with one or more embodiments.

FIG. 4 illustrates a plan view of the example camera module from which a shield can is removed.

FIG. 5 illustrates an exploded perspective view of a reflection module disposed in a housing.

FIG. 6 illustrates an exploded perspective view of the reflection module seen from a different angle.

FIG. 7 illustrates an arrangement structure of a magnet, a ball member, and a yoke when the reflection module is disposed in a neutral position, in accordance with one or more embodiments.

FIG. 8 illustrates an arrangement structure of the magnet, the ball member, and the yoke when the reflection module is rotated, in accordance with one or more embodiments.

FIG. 9 illustrates an arrangement structure of the magnet, the ball member, and the yoke when the reflection module is disposed in a neutral position, in accordance with one or more embodiments.

FIG. 10 illustrates an arrangement structure of the magnet, the ball member, and the yoke when the reflection module is rotated, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more example may provide a camera module in which a reflection module may return to its original neutral position without a separate power supply when a current applied to an actuator is recovered after the reflection module is driven and rotated by the actuator.

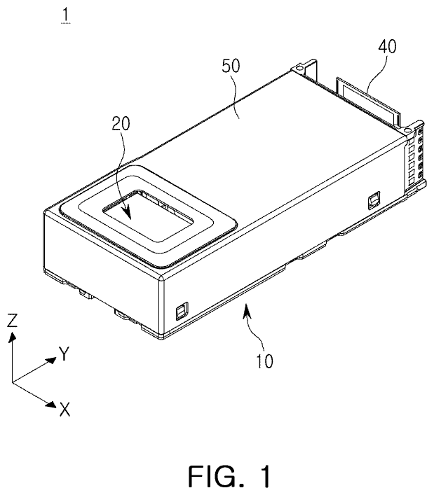

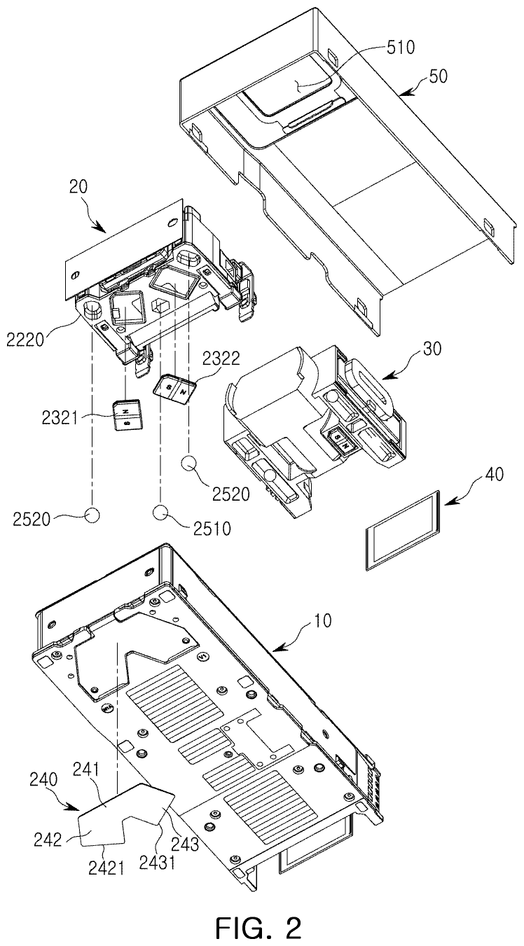

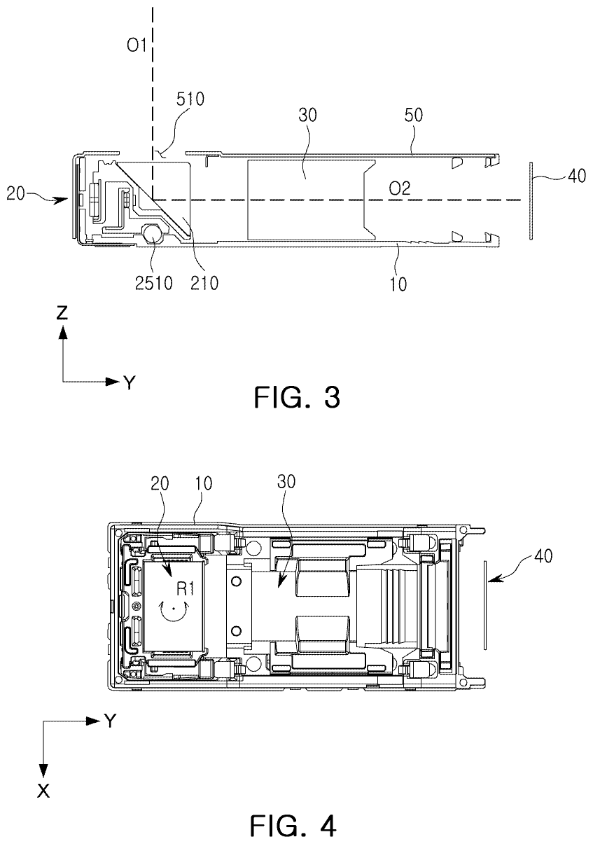

FIG. 1 illustrates a perspective view of an example camera module; FIG. 2 illustrates an exploded perspective view of some of the components in the example camera module; FIG. 3 illustrates a cross-sectional view of the example camera module; and FIG. 4 illustrates a plan view of the example camera module from which a shield can or cover is removed.

Referring to FIGS. 1 through 4, a camera module 1 may include a housing 10, a reflection module 20, a lens module 30, an image sensor 40, and a shield can or cover 50.

The camera module 1 may include the lens module 30. The lens module 30 may have an optical axis different from an optical axis of light incident on the camera module 1. That is, referring to FIG. 3, a first optical axis O1 refers to the optical axis of light incident from an external subject to the reflection module 20 disposed in the camera module 1, and a second optical axis O2 refers to the optical axis of light incident on the lens module 30 disposed in the housing 10.

Light incident from the outside onto the reflection module 20 along the first optical axis O1 may pass through the lens module 30 along the second optical axis O2 to reach the image sensor 40. The first optical axis O1 and the second optical axis O2 may not be parallel to each other. That is, the first optical axis O1 and the second optical axis O2 may be approximately perpendicular to each other, and an angle between these optical axes is not limited thereto.

The lens module 30 may be disposed in the housing 10, and is movable relative to the image sensor 40. The lens module 30 may be moved forward and backward along the second optical axis O2.

The lens module 30 may be moved forward and backward along the second optical axis O2 to perform an autofocus (AF) operation of the camera module.

The reflection module 20 may be accommodated in an internal space of the housing 10, and may change a path of light incident on the reflection module 20. In an example, the reflection module 20 may include at least some of a reflection member 210 which changes the path of light, components that support and drive the reflection member 210, and a holder 220 that accommodates these components.

The reflection member 210 of the reflection module 20 may change the progression path of light by refracting or reflecting light, and may be for example, a prism or mirror that changes the optical path by refracting or reflecting light.

The reflection member 210 may refract light incident from the outside and change the path of light toward the lens module 30. For example, the reflection member 210 may change the progression path of light incident along the first optical axis O1 to be approximately parallel to the second optical axis O2. Accordingly, as shown in FIG. 3, light incident from the outside of the camera module 1 to the reflection module 20 may change its progression path while passing through the reflection module 20 to be incident on the lens module 30. Light incident on the lens module 30 may be appropriately refracted while passing through the lens module 30 to be incident on the image sensor 40.

In an example, the reflection member 210 may be rotatable or movable in the housing 10. The path of light may be appropriately changed based on the rotation or movement of the reflection member 210. The camera module 1 may perform an optical image stabilization (OIS) operation by rotating or moving the reflection member 210.

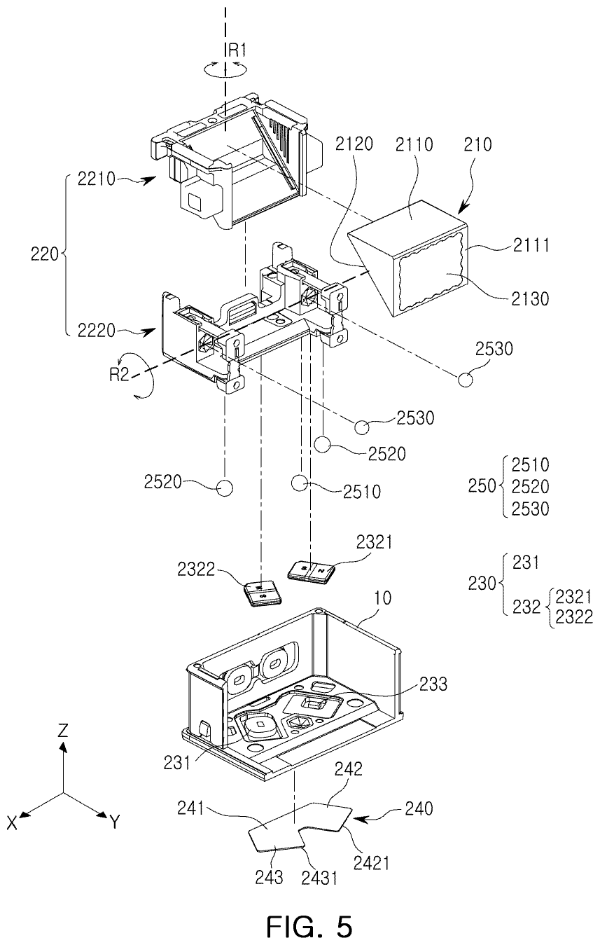

The reflection member 210 may have a plurality of rotation axes to be rotated in different directions. For example, referring to FIGS. 4 and 5, the reflection member 210 may be rotated about a first rotation axis R1 parallel to the first optical axis O1. Alternatively, the reflection member 210 may also be rotated about a second rotation axis R2 perpendicular to both the first optical axis O1 and the second optical axis O2. By this rotation, the reflection member 210 may change the progression path of light to be approximately parallel to the second optical axis O2.

In the following description, the first rotation axis R1 may also be briefly referred to as a “first axis,” and the second rotation axis R2 may also be briefly referred to as a “second axis”. That is, unless otherwise indicated as “the optical axis,” “the first axis or the second axis” may be understood as “the first rotation axis or second rotation axis” of the reflection module 20.

Additionally, an axis perpendicular to both the first rotation axis and the second rotation axis may be defined as a “third axis”. In an example, the second optical axis O2 may be approximately parallel to the third axis.

The camera module 1 may include the image sensor 40 on which light that passed through the reflection module 20 and the lens module 30 is incident. The image sensor 40 may convert incident light into image information. The image sensor 40 may have a light collection surface facing an emission surface of the lens module 30, and may generate an electrical signal corresponding to light incident from the lens module 30.

The image sensor 40 may be accommodated in the housing 10, or may be disposed outside the housing 10.

A filter unit that filters at least some of light incident from the lens module 30 may be disposed in front of the image sensor 40. The filter unit may include an optical filter (for example, an infrared ray (IR) cut filter) which may block light of a specific wavelength. Alternatively, the filter unit may include a light blocking member (e.g., baffle) that blocks at least some of light incident from the lens module 30.

The housing 10 may have an internal space to accommodate at least one of the reflection module 20, the lens module 30, or the image sensor 40. The housing 10 may be made of a material having a predetermined rigidity to protect the components accommodated therein. In an example, the housing 10 may be a box-shaped member having an open top. However, the material or shape of the housing 10 is not limited thereto.

The camera module 1 may include the shield can 50 that covers the top of the housing 10. The shield can 50 may cover the open top of the housing 10 to protect the components in the housing 10 from an external environment. The shield can 50 may include an opening 510 through which incident light passes. External light may be incident on the reflection module 20 through the opening 510.

FIGS. 3 and 4 illustrate that the lens module 30 and the reflection module 20 are accommodated in one housing 10, which is only an example. In an example, the lens module 30 and the reflection module 20 may respectively be accommodated in a plurality of housings, configured as different parts, and then assembled together to form the entire camera module 1. The image sensor 40 may also be disposed in a housing separate from that of the reflection module 20 or the lens module 30. In this example, each individual part may be defined as a lens module assembly, a reflection module assembly, or the image sensor assembly. That is, the camera module 1 may include the reflection module assembly including the reflection module 20, the lens module assembly including one or more lens modules 30, and the image sensor assembly.

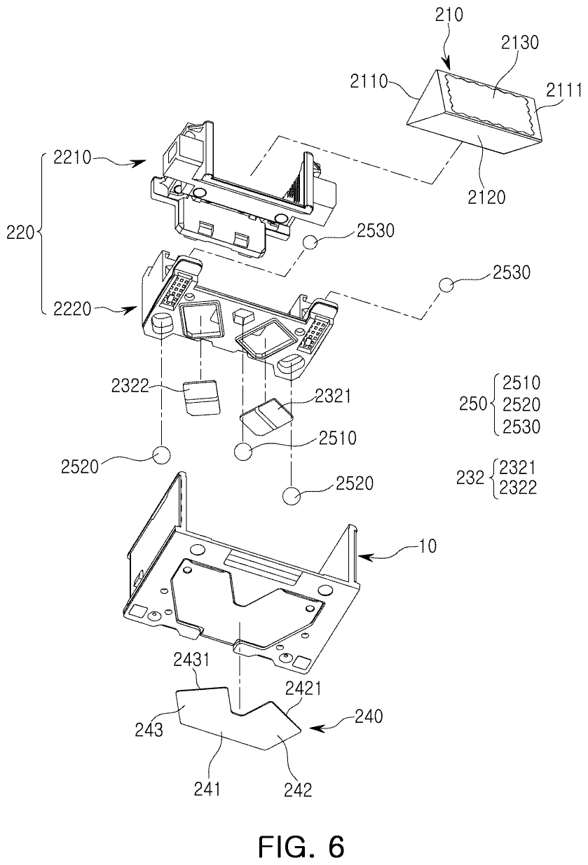

Hereinafter, the reflection module 20 included in the camera module 1 is described in detail with reference to FIGS. 5 and 6. FIG. 5 is an exploded perspective view of the reflection module 20 disposed in the housing; and FIG. 6 is an exploded perspective view of the reflection module 20 disposed in the housing 10, seen from a different angle.

Referring to FIGS. 5 and 6, the reflection module 20 may include the reflection member 210 accommodated in the housing 10, and which changes the optical path. The reflection member 210 may include an incident surface 2110 on which light may be incident through the opening 510 of the shield can 50, and an emission surface 2130 through which light may be emitted.

The reflection member 210 may be movable in the housing 10. For example, the reflection member 210 may be rotated about the different rotation axes R1 and R2.

Referring to FIGS. 5 and 6, the reflection module 20 may include a reflection member 210 that changes the optical path, a reflection holder 2210 and a rotation holder 2220 that support the reflection member 210 to be movable.

The reflection member 210 may change the progression path of light by refracting or reflecting incident light.

The reflection member 210 may include the incident surface 2110 on which light is incident, a reflection surface 2120 on which light is reflected, and the emission surface 2130 on which reflected light is emitted. For example, light incident on the light incident surface 2110 in the first direction (Z-axis direction) may be reflected from the reflection surface 2120 to be emitted in the second direction (Y-axis direction). In an example, the first direction (Z-axis direction) may be approximately parallel to the first optical axis O1 along which light is incident on the reflection member, and the second direction (Y-axis direction) may be approximately parallel to the second optical axis O2 of the lens module 30.

The reflection member 210 may include a light blocking part 2111 that reduces a flare by blocking unnecessary light. For example, as shown in FIGS. 5 and 6, the light blocking part that blocks unnecessary light may be disposed at an edge of the emission surface 2130 of the reflection member 210. However, a position of the light blocking part 2111 is not limited thereto, and may be disposed on the incident surface 2110. Additionally, although not shown in the drawings, separate from the light blocking part 2111, a light blocking member that performs a similar operation as that of the light blocking part 2111 may be disposed while being spaced apart from the reflection member 210.

The reflection member 210 may be disposed in the reflection holder 2210. The reflection holder 2210 may support the reflection member 210, and may be rotated or moved. For example, the reflection holder 2210 may be rotated about the second rotation axis R2 passing through at least two ball members 2530, and accordingly, the reflection member 210 disposed in the reflection holder 2210 may also be rotated together.

The reflection module 20 may further include the rotation holder 2220 that supports the reflection holder 2210 to be movable or rotatable. The rotation holder 2220 may be rotatable or movable relative to the housing 10 while simultaneously supporting the reflection holder 2210 to be rotatable. For example, the reflection holder 2210 may be rotatably supported by the rotation holder 2220 while having at least two ball members 250 forming the rotation axis and interposed therebetween.

The rotation holder 2220 may be supported by the housing 10 while having at least one ball member 250 interposed therebetween, and thus be rotatable relative to the housing 10 by centering on another rotation axis formed by at least one ball member 250. In order to distinguish the respective rotation axes, in the following description, the rotation axis of the rotation holder 2220 is referred to as the first rotation axis R1, and the rotation axis of the reflection holder 2210 is referred to as the second rotation axis R2.

In the reflection module 20, in accordance with one or more embodiments, the first rotation axis R1 and the second rotation axis R2 may be different from each other. For example, the first rotation axis R1 and the second rotation axis R2 may be approximately perpendicular to each other.

The first axis rotation R1 may pass through the incident surface 2110 and reflection surface 2120 of the reflection member 210. The second axis rotation R2 may be approximately parallel to the reflection surface 2120 of the reflection member 210. For example, the second rotation axis R2 may be disposed on the reflection surface 2120, or may be parallel to the reflection surface 2120 while having a predetermined distance therefrom.

In the reflection module 20, the first rotation axis R1 and the second rotation axis R2 may meet each other at one point. Here, the point where the first rotation axis R1 and the second rotation axis R2 meet each other may be disposed on the reflection surface 2120 of the reflection member 210, or may be disposed to be adjacent to the reflection surface 2120.

When the reflection module 20 is in a neutral position, the incident surface 2110 of the reflection member 210 may be approximately perpendicular to the first optical axis O1 along which light is incident through the opening 510 of the shield can 50, and the emission surface 2130 of the reflection member 210 may be approximately perpendicular to the second optical axis O2 of the lens module 30. In this example, the first rotation axis R1 of the reflection module 20 may approximately coincide with the first optical axis O1 along which light is incident on the reflection member, and the second rotation axis R2 of the reflection module 20 may be perpendicular to both the first optical axis O1 and the second optical axis O2. Additionally, similar to the intersection point of the first rotation axis R1 and the second rotation axis R2, an intersection point of the first optical axis O1 and the second optical axis O2 may be positioned on the reflection surface 2120 of the reflection member 210.

In the one or more examples, the reflection module 20 may include a driving unit 230 which drives the rotation holder 2220.

The driving unit 230 may include a coil 231 and a magnet 232. In an example, the driving unit 230 may rotate the rotation holder 2220 based on an electromagnetic interaction between the coil 231 and the magnet 232 facing each other. In an example, the coil 231 included in the driving unit 230 may be referred to as a driving coil, and the magnet 232 included in the driving unit 230 may be referred to as a driving magnet.

In the camera module, the driving magnet 232 and the driving coil 231 may respectively be disposed on two components which perform relative motions. In an example, the driving magnet may be disposed on the rotation holder 2220, and the driving coil may be disposed in the housing 10.

The driving unit 230 may include a position sensor 233 that detects a movement amount of the magnet 232. In an example, the driving unit 230 may include the position sensor 233 which faces the driving magnet 232. The position sensor 233 may be disposed around, and parallel to, the coil 231, or may be disposed in the coil 231.

In the neutral position (or an original position) of the reflection module 20, the position sensor 233 may face a neutral region of the magnet 232. In an example, the neutral region of the magnet 232 may indicate a boundary region of two different polarities (e.g., north (N) pole and south (S) pole).

In an example, a yoke 240 may be disposed in the housing 10, and may face the magnet 232 in the first direction. In an example, as shown in FIG. 6, the yoke 240 may be disposed on a lower surface of the housing 10, and may overlap the magnet 232 in the first direction. An attractive force may act between the yoke 240 and the magnet 232. Accordingly, the reflection module 20 may be pulled toward the lower surface of the housing 10 by the yoke 240.

Hereinafter, the description describes in detail the rotation holder 2220 included in the reflection module 20.

The reflection module 20 may include the rotation holder 2220 that is rotatable relative to the housing 10. The rotation holder 2220 may be rotatable relative to the housing 10 while supporting the reflection holder 2210 or the reflection member 210 to be rotatable. In an example, the rotation holder 2220 may be rotatable about the first rotation axis R1, and accordingly, the reflection member 210 may also be rotated about the first rotation axis R1 together with the rotation holder 2220.

The plurality of ball members 250 may be disposed between the rotation holder 2220 and the housing 10, and may support the rotation holder 2220 to be rotatable.

The plurality of the ball members 250 may include a first ball member 2510 that forms the rotation axis (hereinafter, the first rotation axis R1) of the rotation holder 2220, and at least one guide ball member 2520 that assists a stable rotation of the rotation holder 2220.

The first ball member 2510 may form the first rotation axis R1 while being rotated in place while its position is fixed relative to the housing 10. Accordingly, the first rotation axis R1 may pass through the first ball member 2510.

The first rotation axis R1 may approximately coincide with the first optical axis O1 of the first lens module 30 facing the reflection module 20. Accordingly, an imaginary line extending along the first optical axis O1 may pass through the first ball member 2510.

One or more guide ball members 2520 may be disposed in the reflection module 20. In an example, as shown in FIGS. 5 and 6, the reflection module 20 may include two guide ball members 2520 spaced apart from the first ball member 2510. The guide ball member 2520 may perform a rolling movement relative to the housing 10 or the rotation holder 2220, and may support the rotation holder 2220 to allow the rotation holder 2220 to be rotated while maintaining a predetermined distance from a bottom surface of the housing 10.

A driving force to rotate the rotation holder 2220 may be generated by the driving unit 230. In an example, the driving unit 230 may include the magnet 232, the coil 231, and the yoke 240, which are disposed separately in the rotation holder 2220 and the housing 10, and may generate the driving force based on the electromagnetic interaction between the magnet 232 and the coil 231.

The magnet 232 and the coil 231 may face each other in the first direction (Z-axis direction). In an example, the first direction (Z-axis direction) may be a direction approximately parallel to the first rotation axis R1 which is the rotation axis of the rotation holder 2220.

The magnet 232 may face the coil 231 on a lower surface of the rotation holder 2220. The magnet 232 may have different polarities sequentially magnetized in a rotation direction of the rotation holder 2220. For example, a surface of a first driving magnet 2321 or a second driving magnet 2322 that faces the coil 231 may have the N pole, the neutral region, and the S pole sequentially formed in the rotation direction of the rotation holder 2220.

The driving unit 230 may include the position sensor 233 that detects a position of the magnet 232. The position sensor 233 may be a magnetic sensor disposed on the inside or outside of the coil 231. In a non-limited example, the position sensor 233 may include a hall sensor. The position sensor 233 may detect the movement amount of the magnet 232 by detecting a change in a magnetic flux passing through the position sensor 233.

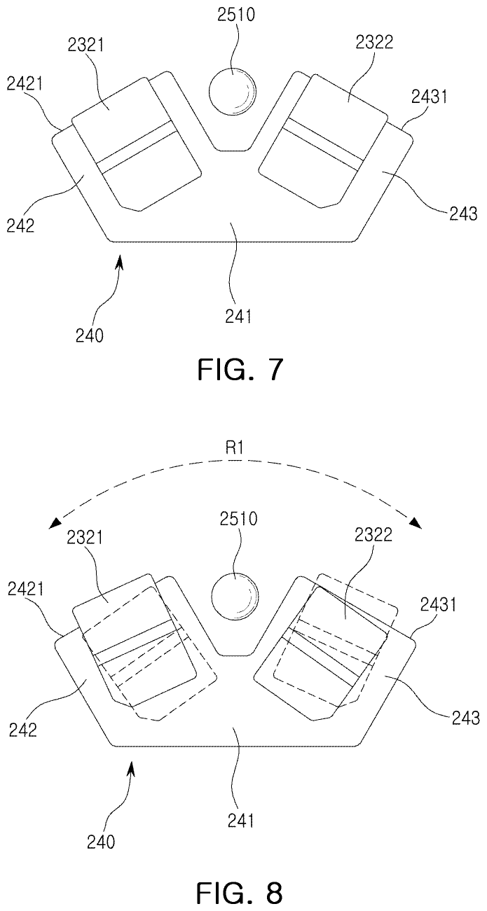

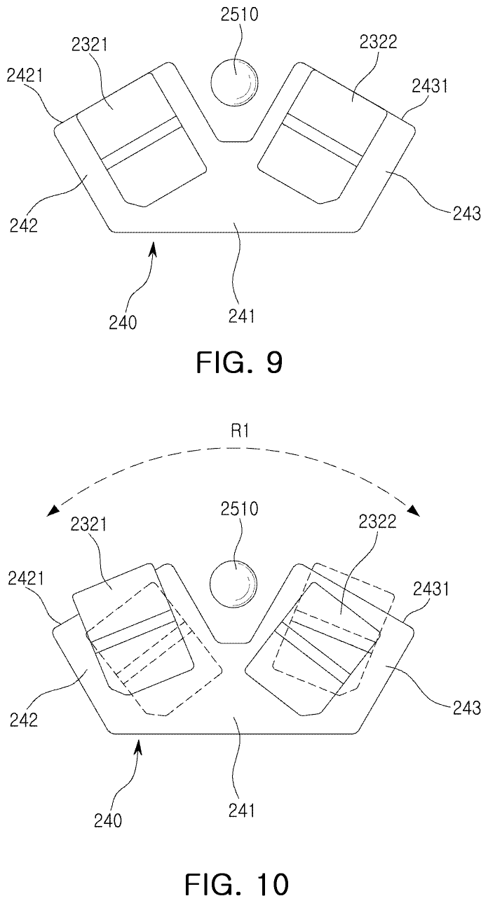

The description describes the structure and operation of the magnet and the yoke with reference to FIGS. 7 through 10. FIGS. 7 and 8 are views of the structure and operation of the magnet and the yoke, in accordance with one or more embodiments; and FIGS. 9 and 10 are views of the structure and operation of the magnet and the yoke, in accordance with one or more embodiments.

FIG. 7 illustrates an example in which the reflection module 20 is in a neutral position (or an original position), in accordance with one or more embodiments, and FIG. 8 illustrates an example in which the reflection module 20 is rotated, in accordance with one or more embodiments.

FIG. 9 illustrates an example in which the reflection module 20 is in a neutral position, in accordance with one or more embodiments, and FIG. 10 illustrates an example in which the reflection module 20 is rotated, in accordance with one or more embodiments.

The magnet 232 may be disposed on a lower surface of the reflection module 20. The magnet 232 may include the first driving magnet 2321 and the second driving magnet 2322. The first driving magnet 2321 and the second driving magnet 2322 may be spaced apart from each other while having the first ball member 2510 interposed therebetween.

The yoke 240 may be disposed in the housing 10. The yoke 240 may be spaced apart from the rotation holder 2220 in the first direction. In an example, the yoke 240 may have a flat shape. In an example, the yoke 240 may be made of metal. The yoke 240 may be a metal material that is attracted by a magnetic field. The yoke 240 may include a main body 241, a first extension 242, and a second extension 243.

The first extension 242 may protrude from the main body 241. The second extension 243 may protrude from the main body 241. The first extension 242 and the second extension 243 may be spaced apart from each other. That is, a space may be disposed between the first extension 242 and the second extension 243. The yoke 240 may have a shape close to a “V” or “U” shape.

The first ball member 2510 may be disposed in the space between the first extension 242 and the second extension 243. The first ball member 2510 may support the rotation of the reflection module. The reflection member 210 may be rotated while having the first ball member 2510 as its rotation center.

An end of the first extension 242 may be referred to as a first edge 2421 of the yoke, and an end of the second extension 243 may be referred to as a second edge 2431 of the yoke.

Referring to FIG. 7, the description describes the structure where the reflection module 20 is disposed in the neutral position (or the original, pre-rotation position), in accordance with one or more embodiments.

In the neutral position (or the pre-rotation position), the first driving magnet 2321 may face the yoke 240. That is, the first driving magnet 2321 may overlap the yoke 240 in the first direction. Specifically, the first driving magnet 2321 may overlap the first extension 242 of the yoke 240 in the first direction. However, a portion (for example, a first portion) of the first driving magnet 2321 may overlap a portion of the yoke 240 in the first direction. That is, the other portion (for example, a second portion) of the first driving magnet 2321 may not overlap the yoke 240 in the first direction. Accordingly, the end of the first driving magnet 2321 may be spaced apart from the first edge 2421 of the yoke in the direction perpendicular to the first direction.

In the neutral position, the second driving magnet 2322 may face the yoke 240. That is, the second driving magnet 2322 may overlap the yoke 240 in the first direction. Specifically, the second driving magnet 2322 may overlap the second extension 243 of the yoke 240 in the first direction. However, a portion of the second driving magnet 2322 may overlap a portion of the yoke 240 in the first direction. That is, the other portion of the second driving magnet 2322 may not overlap the yoke 240 in the first direction. Accordingly, the end of the second driving magnet 2322 may be spaced apart from the second edge 2431 of the yoke in the direction perpendicular to the first direction.

In the neutral position, the magnetic attraction or force may act between the first driving magnet 2321 and the yoke 240 in the direction perpendicular to the first direction. Additionally, the magnetic attraction may act between the second driving magnet 2322 and the yoke 240 in the direction perpendicular to the first direction. However, the magnetic attraction acting between the first driving magnet 2321 and the yoke 240 and the magnetic attraction acting between the second driving magnet 2322 and the yoke 240 are in balance. Therefore, the reflection module 20 may be disposed in the neutral position without being rotated.

Referring to FIG. 8, the description describes the structure when the reflection module 20 is rotated, in accordance with one or more embodiments.

In FIG. 8, the driving magnet 2322 shown in a solid line illustrates an example in which the reflection module 20 is rotated clockwise, and the driving magnet 2322 shown in a dotted line illustrates an example in which the reflection module 20 is rotated counterclockwise.

When the reflection module 20 is rotated clockwise, an area where the first driving magnet 2321 and the yoke 240 face each other may be reduced. To the contrary, an area where the second driving magnet 2322 and the yoke 240 face each other may be increased. That is, the area where the second extension 243 and the second driving magnet 2322 overlap each other in the first direction may be increased when the area where the first extension 242 and the first driving magnet 2321 overlap each other in the first direction is reduced as the reflection module 20 is rotated.

Therefore, the magnetic attraction acting between the first driving magnet 2321 and the yoke 240 and the magnetic attraction acting between the second driving magnet 2322 and the yoke 240 may have different sizes and directions. In other words, the attraction acting between the first driving magnet 2321 and the yoke 240 may be inversely proportional to the attraction acting between the second driving magnet 2322 and the yoke 240.

Specifically, when the reflection module 20 is rotated clockwise, the magnetic attraction acting between the first driving magnet 2321 and the yoke 240 in the direction perpendicular to the first direction may be greater than the magnetic attraction acting between the second driving magnet 2322 and the yoke 240 in the direction perpendicular to the first direction. Therefore, the reflection module 20 may be rotated counterclockwise based on the magnetic attraction when a current is not applied to the driving coil 231 after the reflection module 20 is rotated clockwise.

When the reflection module 20 is rotated counterclockwise, the area where the first driving magnet 2321 and the yoke 240 face each other may be increased. To the contrary, the area where the second driving magnet 2322 and the yoke 240 face each other may be reduced.

Therefore, the magnetic attraction acting between the first driving magnet 2321 and the yoke 240 and the magnetic attraction acting between the second driving magnet 2322 and the yoke 240 may have different sizes and directions.

Specifically, when the reflection module 20 is rotated clockwise about the first rotation axis, the magnetic attraction acting between the second driving magnet 2322 and the yoke 240 in the direction perpendicular to the first direction may be greater than the magnetic attraction acting between the first driving magnet 2321 and the yoke 240 in the direction perpendicular to the first direction. Therefore, the reflection module 20 may be rotated clockwise based on the magnetic attraction when the current is not applied to the driving coil 231 after the reflection module 20 is rotated counterclockwise.

In accordance with one or more embodiments, the reflection module 20 may be rotated clockwise or counterclockwise based on the magnetic attraction acting between the driving magnet 2322 and the yoke 240 when the current is not applied to the driving coil 231 after the reflection module 20 is rotated, and the reflection module 20 may thus return to the neutral position.

Referring to FIG. 9, the description describes the structure where the reflection module 20 is disposed in a neutral position, in accordance with one or more embodiments.

In the neutral position, the first driving magnet 2321 may face the yoke 240. That is, the first driving magnet 2321 may overlap the yoke 240 in the first direction. Specifically, the first driving magnet 2321 may overlap the first extension 242 of the yoke 240 in the first direction. That is, the entire first driving magnet 2321 may overlap the yoke 240 in the first direction. Additionally, one end of the first driving magnet 2321 may be disposed to be adjacent to the edge of the yoke 240. Specifically, one end of the first driving magnet 2321 may partially overlap the edge of the yoke 240 in the first direction. In other words, the end of the first driving magnet 2321 may overlap the first edge 2421 of the yoke 240 in the direction perpendicular to the first direction.

In the neutral position, the second driving magnet 2322 may face the yoke 240. That is, the second driving magnet 2322 may overlap the yoke 240 in the first direction. Specifically, the second driving magnet 2322 may overlap the second extension 243 of the yoke 240 in the first direction. The entire second driving magnet 2322 may overlap the yoke 240 in the first direction. Additionally, the end of the second driving magnet 2322 may overlap the second edge 2431 of the yoke 240 in the direction perpendicular to the first direction.

The magnetic attraction acting between the first driving magnet 2321 and the yoke 240 and the magnetic attraction acting between the second driving magnet 2322 and the yoke 240 are in balance. Therefore, the reflection module 20 may be disposed in the neutral position without being rotated.

Referring to FIG. 10, the description describes the structure when the reflection module 20 is rotated, in accordance with one or more embodiments.

In FIG. 10, the driving magnet 2322 shown in a solid line illustrates an example in which the reflection module 20 is rotated clockwise, and the driving magnet 2322 shown in a dotted line illustrates an example in which the reflection module 20 is rotated counterclockwise.

When the reflection module 20 is rotated clockwise about the first rotation axis, the area where the first driving magnet 2321 and the yoke 240 face each other may be reduced. To the contrary, the area where the second driving magnet 2322 and the yoke 240 face each other may be increased. In this example, the end of the first driving magnet 2321 may be clockwise closer to the main body 241 of the yoke 240, and the end of the second driving magnet 2322 may be clockwise further away from the main body 241 of the yoke 240.

Therefore, the magnetic attraction acting between the first driving magnet 2321 and the yoke 240 and the magnetic attraction acting between the second driving magnet 2322 and the yoke 240 may have different sizes and directions. In other words, the attraction acting between the first driving magnet 2321 and the yoke 240 may be inversely proportional to the attraction acting between the second driving magnet 2322 and the yoke 240.

Specifically, when the reflection module 20 is rotated clockwise, the magnetic attraction acting between the first driving magnet 2321 and the yoke 240 in the direction perpendicular to the first direction may be greater than the magnetic attraction acting between the second driving magnet 2322 and the yoke 240 in the direction perpendicular to the first direction. Therefore, the reflection module 20 may be rotated counterclockwise based on the magnetic attraction when the current is not applied to the driving coil 231 after the reflection module 20 is rotated clockwise.

When the reflection module 20 is rotated counterclockwise, the area where the first driving magnet 2321 and the yoke 240 face each other may be increased. To the contrary, the area where the second driving magnet 2322 and the yoke 240 face each other may be reduced.

The area where the second extension 243 and the second driving magnet 2322 overlap each other in the first direction may be increased when the area where the first extension 242 and the first driving magnet 2321 overlap each other in the first direction is reduced as the reflection module 20 is rotated.

The end of the first driving magnet 2321 may be counterclockwise close to the main body 241 of the yoke 240, and the end of the second driving magnet 2322 may be counterclockwise away from the main body 241 of the yoke 240.

Therefore, the magnetic attraction acting between the second driving magnet 2322 and the yoke 240 and the magnetic attraction acting between the first driving magnet 2321 and the yoke 240 may have different sizes and directions.

Specifically, when the reflection module 20 is rotated counterclockwise, the magnetic attraction acting between the second driving magnet 2322 and the yoke 240 in the direction perpendicular to the first direction may be greater than the magnetic attraction acting between the first driving magnet 2321 and the yoke 240 in the direction perpendicular to the first direction. Therefore, the reflection module 20 may be rotated clockwise based on the magnetic attraction when the current is not applied to the driving coil 231 after the reflection module 20 is rotated counterclockwise.

In accordance with one or more embodiments, the reflection module 20 may be rotated clockwise or counterclockwise based on the magnetic attraction acting between the driving magnet 2322 and the yoke 240 when the current is not applied to the driving coil 231 after the reflection module 20 is rotated, and the reflection module 20 may thus return to the neutral position.

As set forth above, in accordance with one or more embodiments, it is possible to provide the camera module having more of the lens modules without increasing its overall length by disposing the lens modules in front and behind the reflection module.

In accordance with one or more embodiments, it is possible to provide the reflection module which may accurately detect the movement amount of the moving object even when an external impact is applied thereto, and the camera module including the same.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a reflection module disposed in the housing, and configured to receive light in a first direction; and
a yoke disposed in the housing,
wherein the reflection module comprises:
a magnet disposed on a lower portion of the reflection module, and
a ball member disposed between the reflection module and the housing, and configured to support a rotation of the reflection module,
wherein when the reflection module is in a neutral position, a portion of the magnet is disposed in a non-overlapping manner with the yoke in the first direction.

2. The camera module according to claim 1, wherein the magnet comprises a first driving magnet and a second driving magnet spaced apart from each other while having the ball member interposed therebetween.

3. The camera module according to claim 2, wherein when the reflection module is rotated from the neutral position, a magnetic force acting between the first driving magnet and the yoke in a direction perpendicular to the first direction is inversely proportional to a magnetic force acting between the second driving magnet and the yoke in the direction perpendicular to the first direction.

4. The camera module according to claim 1, wherein a magnetic force acting between the magnet and the yoke is changed when the reflection module is rotated from the neutral position.

5. The camera module according to claim 2, wherein when the reflection module is in the neutral position, a first portion of the first driving magnet overlaps a first portion of the yoke in the first direction, and
a first portion of the second driving magnet overlaps a second portion of the yoke in the first direction.

6. The camera module according to claim 1, wherein the yoke comprises a main body, a first extension portion and a second extension portion respectively protruding from the main body, and
the ball member is disposed between the first extension portion and the second extension portion.

7. The camera module according to claim 6, wherein:
the magnet comprises a first driving magnet and a second driving magnet that are spaced apart from each other while having the ball member interposed therebetween,
a first portion of the first driving magnet overlaps the first extension portion in the first direction, and
a first portion of the second driving magnet overlaps the second extension portion in the first direction.

8. The camera module according to claim 6, wherein the magnet comprises a first driving magnet and a second driving magnet that are spaced apart from each other while having the ball member interposed therebetween, and
when the reflection module is in the neutral position, an end portion of the first driving magnet is spaced apart from an end portion of the first extension portion in a direction perpendicular to the first direction, and
an end portion of the second driving magnet is spaced apart from an end portion of the second extension portion in the direction perpendicular to the first direction.

9. The camera module according to claim 7, wherein an area where the second extension portion and the second driving magnet overlap each other is increased when an area where the first extension portion and the first driving magnet overlap each other is reduced when the reflection module is rotated.

10. The camera module according to claim 1, wherein the yoke has a “U” shape.

11. A camera module, comprising:
a housing;
a reflection module disposed in the housing, and configured to receive light in a first direction;
a yoke disposed in the housing;
a magnet disposed on a lower portion of the reflection module; and
a ball member disposed between the reflection module and the housing, to configured to support a rotation of the reflection module,
wherein when the reflection module is in a neutral position, an entirety of the magnet overlaps the yoke in the first direction, and
one end of the magnet partially overlaps an edge of the yoke in the first direction.

12. The camera module according to claim 11, wherein the magnet comprises a first driving magnet and a second driving magnet spaced apart from each other while having the ball member interposed therebetween.

13. The camera module according to claim 12, wherein when the reflection module is rotated from the neutral position, a magnetic force acting between the first driving magnet and the yoke in a direction perpendicular to the first direction is inversely proportional to a magnetic force acting between the second driving magnet and the yoke in the direction perpendicular to the first direction.

14. The camera module according to claim 12, wherein the yoke comprises a main body, a first extension portion and a second extension portion respectively protruding from the main body, and
the ball member is disposed between the first extension portion and the second extension portion.

15. The camera module according to claim 14, wherein an area where the second extension portion and the second driving magnet overlap each other is increased when an area where the first extension portion and the first driving magnet overlap each other is reduced when the reflection module is rotated.

16. The camera module according to claim 14, wherein when the reflection module is rotated clockwise, an end of the first driving magnet is closer to the main body in a clockwise direction, and an end of the second driving magnet is further away from the main body in a clockwise direction.

17. A camera module, comprising:
a housing;
a reflection module disposed in the housing;
a first driving magnet and a second driving magnet respectively disposed on a lower portion of the reflection module; and
a yoke disposed in the housing to face the first driving magnet and the second driving magnet in a first axis direction;
wherein when the reflection module is disposed in a first position, a first end of the first driving magnet is substantially equal to a first end of the yoke, and a first end of the second driving magnet is substantially equal to a second end of the yoke,
wherein when the reflection module is rotated in a first rotation direction, an overlapping area of the yoke and the first driving magnet is reduced, and an overlapping area of the yoke and the second driving magnet is increased, and
wherein when the reflection module is rotated in a second rotation direction, an overlapping area of the yoke and the first driving magnet is increased, and an overlapping area of the yoke and the second driving magnet is reduced.

18. The camera module of claim 17, wherein the first direction is a clockwise direction, and the second direction is a counterclockwise direction.

19. The camera module of claim 17, wherein when the reflection module is disposed in the first position a magnetic force between the yoke and the first driving magnet is substantially equal to a magnetic force between the yoke and the second driving magnet.
